(19) United States
(12) Patent Application Publication
(10) Pub. No.: US 2008/0123564 A1
(43) Pub. Date: May 29, 2008

(54) COMMUNICATION METHOD PROVIDING FOR COMMUNICATION OF SPECIFIC INFORMATION IN THE CASE OF ACTIVATION OF A SEQUENCE IN RESTRICTED MODE

(75) Inventors: Jean-Michel COLIN, Strasbourg (FR); Franck SAUVE, Plobsheim (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/772,389

(22) Filed: Jul. 2, 2007

(30) Foreign Application Priority Data
Jul. 3, 2006 (FR) 0652768

(51) Int. Cl. H04L 12/16

(52) U.S. Cl. 370/260

(57) ABSTRACT

The invention concerns a method for communication of multimedia information between two or more terminals connected to a network, said method providing:
at least one restricted mode communication sequence in which at least some multimedia information is not communicated and, in the event of activation of the restricted mode communication sequence from at least one terminal:
communicating to at least one other terminal prerecorded information instead of the multimedia information not communicated, in which method said prerecorded information is selected as a function of the terminal to which it is to be sent.

### CROSS-REFERENCE TO RELATED APPLICATIONS

This application is based on French Patent Application No. FR0652768 filed Jul. 3, 2006, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method of communicating multimedia information between two or more terminals connected to a network.

The invention applies in particular, although not exclusively, to communication of audio and video information in the context of a videoconference set up between two or more users each using a terminal.

2. Description of the Prior Art

In the above type of communication, providing sequences in which at least one user suspends video communication (commonly called a “video mute” sequence) or audio and video communication (commonly called a “hold” sequence) is known in itself.

During these restricted mode communication sequences, suspended information is no longer available in the network and users may see a black screen or a replacement icon.

This method of managing these sequences is unsatisfactory in particular because users can mistake it for a technical communication incident. This therefore results in users perceiving a degraded quality of service.

There is known from the document US-2005/0034079 a conference service that provides a user profile describing a specific content to be communicated to other users during a pause in communication. However, this type of service is unsatisfactory because it does not consider the specifics of the users to whom the information is sent.

An object of the invention is to alleviate the drawbacks of the prior art, in particular by proposing a method for communication of multimedia information between two or more terminals connected to a network, said method in particular maximizing the value of restricted mode communication sequences.

### SUMMARY OF THE INVENTION

To this end, the invention proposes a method for communication of multimedia information between two or more terminals connected to a network, said method providing:

at least one restricted mode communication sequence in which at least some multimedia information is not communicated and, in the event of activation of the restricted mode communication sequence of at least one terminal:

communicating to at least one other terminal prerecorded information instead of the multimedia information not communicated, in which method said prerecorded information selected as a function of the terminal to which it is to be sent.

Thus the method of the invention adds value to restricted mode sequences as well as making communication between terminals more user friendly.

Other features and advantages of the invention will become apparent in the course of the following description of various particular embodiments.

### DETAILED DESCRIPTION OF PREFERRED EMBODIMENTS

The invention relates to a method for communication of multimedia information between two or more terminals connected to a network. The invention is described hereinafter in relation to a videoconference network in which pictures and sound are communicated between users connected to the network.

For this purpose, the user has a terminal, said terminals conventionally comprising image and sound capture means as well as means for viewing and listening to information communicated by other users. In particular, the viewing means can display a plurality of windows in each of which the image communicated by one of the users can be seen.

Alternatively, the method of the invention applies equally in the context of communication of multimedia information between two terminals connected to a network.

The information can be communicated via a mobile or cable telecommunication network or via an Internet network. However, the invention is in no way limited to any particular mode of communication of multimedia information or to any implementation of the terminals connected to the communication network.

The communication method provides at least one restricted mode communication sequence in which at least one item of information is not communicated. In one embodiment, this communication sequence provides for not communicating video information and/or not communicating multimedia information.

These sequence types, conventionally called a “video mute” sequence and a “hold” sequence, respectively, are provided to enable a user to suspend communication of at least some of the information that he is sending for a particular time period, for example for reasons of confidentiality.

For this purpose, terminals are equipped with means actuated by the user of the terminal for activating each of the available restricted mode communication sequences, said means being adapted to be. Furthermore, there may be provision for activating the restricted mode communication sequences only for certain users, for example to continue a call only with other users.

In the case of activation of a restricted mode communication sequence from at least one terminal, the communication method communicates to at least one other terminal prerecorded information in place of the multimedia information that is not communicated.

Furthermore, the prerecorded information is selected as a function of the terminal to which it is to be sent. The method therefore substitutes for the multimedia information prerecorded information that is suited to users receiving the restricted mode sequence.

The prerecorded information can be of any type, in particular audio or video, fixed or interactive, for commercial purposes or for information. In one embodiment, the method communicates prerecorded information that is of the same type as that suspended in the restricted mode sequence (video without audio in the case of the “video mute” sequence and video with audio in case of the “hold” sequence).

In particular, the prerecorded information is communicated to a terminal as a function of the user of said terminal, the language of said user, the preference of said user. Moreover, the prerecorded information can also be selected as a function of the nature of the restricted mode communication sequence during which it must be communicated.

To this end, before communication, the method can provide for each terminal user to store information as a function of other users and/or the nature of the available restricted mode sequences. Thus on activating a restricted mode sequence, the terminal automatically communicates to each other user the prerecorded information that is intended for it.

Alternatively, the prerecorded information can be sent automatically to a user as a function of a profile by means of which the user is identified in the communication network. In particular, the prerecorded information may be communicated automatically in the language of a user as defined in his profile.

In this variant, during recording of information by a user, the latter can choose between sending information manually or automatically.

In one embodiment, the profile can contain:

a description of the user: language, preferences, etc.;

a description of the type of information to be communicated as a function of the nature of the restricted mode communication sequence;

criteria taking account of the characteristics of the user intended to receive this information.

Thus all of these profiles can be known to the communication network, for example, which will know how to communicate the most suitable content to each user as a function of the characteristics of each user and the nature of the restricted mode communication sequence.

There is claimed:

1. A method for communication of multimedia information between two or more terminals connected to a network, said method providing:
at least one restricted mode communication sequence in which at least some multimedia information is not communicated and, in the event of activation of the restricted mode communication sequence of at least one terminal:
communicating to at least one other terminal prerecorded information instead of the multimedia information not communicated,
in which method said prerecorded information is selected as a function of the terminal to which it is to be sent.

2. A communication method according to claim 1, wherein said prerecorded information is communicated to a terminal as a function of the user of said terminal, the language of said user, the preferences of said user.

3. A communication method according to claim 1, wherein said prerecorded information is also selected as a function of the nature of the restricted mode communication sequence during which it must be communicated.

4. A communication method according to claim 1, wherein, before communication, information is recorded by the user of a terminal as a function of the users of the other terminals.

5. A communication method according to claim 1, providing a communication sequence in which video information is not communicated.

6. A communication method according to claim 1, providing a communication sequence in which multimedia information is not communicated.
